(19) United States
(12) Patent Application Publication
(10) Pub. No.: US 2026/0086486 A1
(43) Pub. Date: Mar. 26, 2026

(54) PAPER FEEDING DEVICE AND IMAGE FORMING APPARATUS

(71) Applicant: FUJIFILM Business Innovation Corp., Tokyo (JP)

(72) Inventor: Shinya HASEGAWA, Kanagawa (JP)

(73) Assignee: FUJIFILM Business Innovation Corp., Tokyo (JP)

(21) Appl. No.: 19/071,209

(22) Filed: Mar. 5, 2025

(30) Foreign Application Priority Data
Sep. 24, 2024 (JP) 2024-165394

(51) Int. Cl. G03G 15/00

(52) U.S. Cl. CPC G03G 15/6511; G03G 2215/00725

(57) ABSTRACT

A paper feeding device includes a regulation member that includes an abutting portion abutting a leading end of a supplied paper sheet to regulate a transportation start position of the paper sheet and of which the abutting portion moves in a transportation direction of the paper sheet and a detection unit that detects presence or absence of the paper sheet at a position to which the paper sheet is returned in a case where the paper sheet is returned by the regulation member.

### CROSS-REFERENCE TO RELATED APPLICATIONS

This application is based on and claims priority under 35 USC 119 from Japanese Patent Application No. 2024-165394 filed Sep. 24, 2024.

### BACKGROUND

### (i) Technical Field

The present invention relates to a paper feeding device and an image forming apparatus.

### (ii) Related Art

Disclosed in JP2012-131608A is a paper feeding device including a placement portion onto which a recording material can be placed, a roller member that feeds a recording material placed on the placement portion in an one-by-one manner, a pair of side-portion regulation members that regulates the position of the recording material placed on the placement portion in a width direction and of which at least one is movable in the width direction, and a detection unit that is disposed near a nip portion between the recording material and a roller member, that moves along with the side-portion regulation members, and that detects the presence or absence of the recording material based on whether or not the detection unit comes into contact with the recording material on the placement portion.

In addition, disclosed in JP2007-106573A is an image forming apparatus including a manual feed tray that is openable and closable and a manual feed device that feeds a paper sheet to the manual feed tray, the image forming apparatus being configured such that a paper sheet can be manually fed. The manual feed device includes a manual feed table on which paper sheets are loaded, a pickup roller that feeds the loaded paper sheets, a feed roller and a retard roller that separates the fed paper sheets in an one-by-one manner, and a detection unit that detects the position of a leading end of a paper sheet that is set. In the image forming apparatus, the state of detection is checked by the detection unit immediately after a paper feeding command is issued and in a case where a position where the paper sheet is set is not appropriate, a paper feeding operation is not performed and re-setting the paper sheet is requested.

### SUMMARY

A paper feeding device is provided with a regulation member that regulates the position of a leading end of a paper sheet in a transportation direction. In such a paper feeding device, a leading end of a set paper sheet abuts the regulation member for detection of the presence or absence of a paper sheet.

However, in a case where the size of set paper sheets is small, a case where the number of the set paper sheets is small, a case where the paper sheets are flexible, or the like, leading ends of the paper sheets may be pushed back by the regulation member in a case where the paper sheets are set, which may result in erroneous detection of the presence or absence of a paper sheet.

Aspects of non-limiting embodiments of the present disclosure relate to a paper feeding device and an image forming apparatus that detect a set paper sheet without being influenced by the characteristics or the number of paper sheets.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a paper feeding device including a regulation member that includes an abutting portion abutting a leading end of a supplied paper sheet to regulate a transportation start position of the paper sheet and of which the abutting portion moves in a transportation direction of the paper sheet and a detection unit that detects presence or absence of the paper sheet at a position to which the paper sheet is returned in a case where the paper sheet is returned by the regulation member.

### BRIEF DESCRIPTION OF THE DRAWINGS

Exemplary embodiment(s) of the present invention will be described in detail based on the following figures, wherein:

FIG. 1 is a view showing an image forming apparatus according to the present exemplary embodiment;

FIG. 2 is a perspective view showing a manual feed device as seen in a direction along an arrow II of FIG. 1;

FIG. 3 is a view showing the manual feed device as seen from a front side of the paper surface of FIG. 1;

FIG. 4 is an explanatory view for description of the manual feed device in a state where a paper sheet has been supplied to a tray;

FIG. 5 is an explanatory view for description of the manual feed device in a state where a paper sheet supplied to the tray has been pushed back; and

FIGS. 6A to 6C are explanatory views for description of a positional relationship between the opening and closing of the tray of the manual feed device and the feeding roll, where FIG. 6A is a view showing a state where the tray is open, FIG. 6B is a view showing a process in which the tray is closed, and FIG. 6C is a view showing a state where the tray is closed.

### DETAILED DESCRIPTION

Hereinafter, the present exemplary embodiment of the present invention will be described in detail with reference to the accompanying drawings.

### Configuration of Image Forming Apparatus

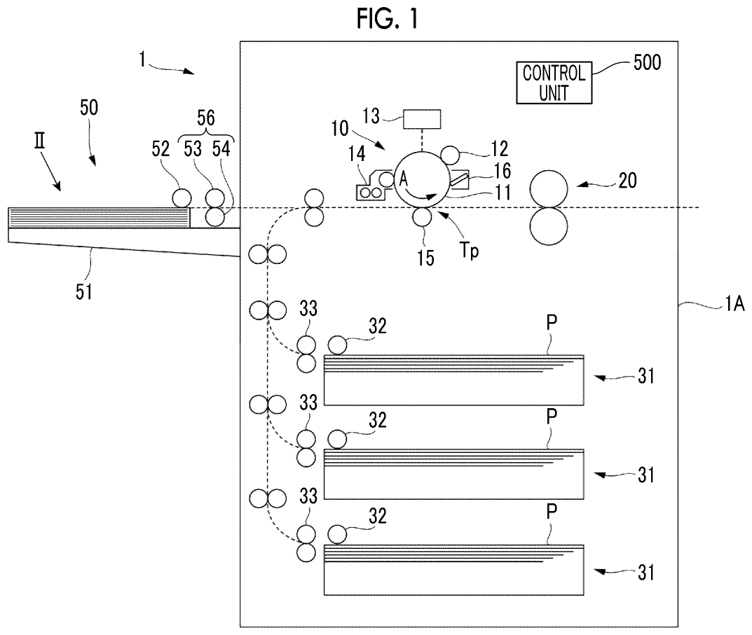

FIG. 1 is a view showing an image forming apparatus 1 according to the present exemplary embodiment. The image forming apparatus 1 is an example of a paper feeding device.

The image forming apparatus 1 includes an image forming unit 10 that forms a toner image on a paper sheet and a fixing unit 20 that heats and presses the toner image that is formed on the paper sheet by the image forming unit 10. In addition, the image forming apparatus 1 includes paper feed trays 31 for supply of, for example, paper sheets of a standard size, such as A4 and B4, to the image forming unit 10. Furthermore, the image forming apparatus 1 includes a manual feed device 50 for supply of a specific paper sheet, such as an envelope or a thick paper sheet, to the image forming unit 10. In addition, the image forming apparatus 1 includes a control unit 500 that controls various operations of the image forming apparatus 1. The control unit 500 controls an image formation operation based on, for example, the result of detection about the presence or absence of a paper sheet.

The image forming unit 10 includes an image holding body 11, a charging device 12, an exposure device 13, a development device 14, a transfer device 15, and a cleaning device 16.

The image holding body 11 includes a photosensitive layer provided on an outer peripheral surface thereof and rotates in a direction along an arrow A shown in FIG. 1. The charging device 12 charges the rotating image holding body 11 to a predetermined potential. The exposure device 13 selectively exposes, to light, the image holding body 11 charged by the charging device 12 such that an electrostatic latent image is formed on the image holding body 11.

The development device 14 develops the electrostatic latent image formed on the image holding body 11 with toner to form a toner image on the image holding body 11. The transfer device 15 transfers the toner image on the image holding body 11 to a paper sheet by forming an electric field between the transfer device 15 and the image holding body 11. The cleaning device 16 removes the toner or the like remaining on the image holding body 11 after the transfer. Hereinafter, in the present specification, a position where the toner image on the image holding body 11 is transferred to the paper sheet will be referred to as a transfer portion Tp.

The image forming apparatus 1 includes a plurality of paper feed trays 31 provided in the housing 1A of the image forming apparatus 1. Each of the paper feed trays 31 includes a feeding roll 32 that comes into contact with an uppermost paper sheet among a plurality of loaded paper sheets and that feeds the uppermost paper sheet to a paper sheet path. In addition, each of the paper feed trays 31 includes a separation mechanism 33 that separates paper sheets fed by the feeding roll 32 in an one-by-one manner and that feeds the paper sheets to a downstream side. The separation mechanism 33 is composed of a feed roll that is disposed to be rotatable and a retard roll of which rotation is limited.

Meanwhile, the manual feed device 50 is used in a case where a user wants to perform printing on a paper sheet of a size that is not set in the paper feed trays 31, an envelope, a thin paper sheet, a film paper sheet, or the like.

In the present exemplary embodiment, the manual feed device 50 is attached to the housing 1A to be openable and closable in a rotary manner. Details of the manual feed device 50 will be described below.

In a case where an instruction to form an image is issued, a paper sheet from the paper feed trays 31 or the manual feed device 50 is transported to the image forming unit 10 by transportation rolls provided in the paper sheet path. A registration roll that supplies, to the transfer portion Tp, a paper sheet transported from the paper feed trays 31 or the manual feed device 50 is attached to the paper sheet path. The registration roll is stopped so that transportation of a paper sheet temporarily stops in a case where the paper sheet is transported from an upstream side. The registration roll starts to rotate at a predetermined time to supply the paper sheet to the transfer portion Tp. A paper sheet onto which an image has been transferred at the transfer portion Tp is subjected to a heating and pressing process performed by the fixing unit 20, so that the image is fixed. Thereafter, the paper sheet is discharged to a discharge tray (not shown) by a transportation roll.

### Manual Feed Device

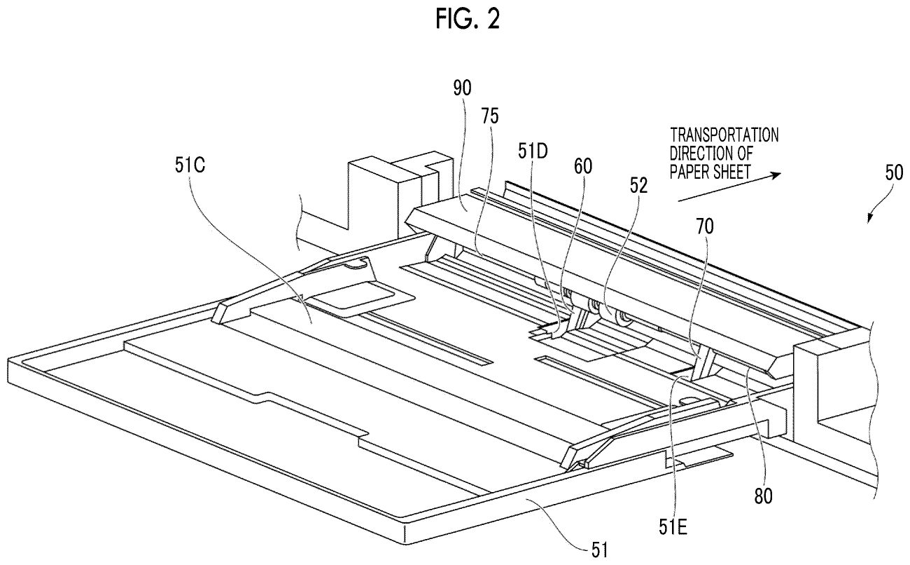

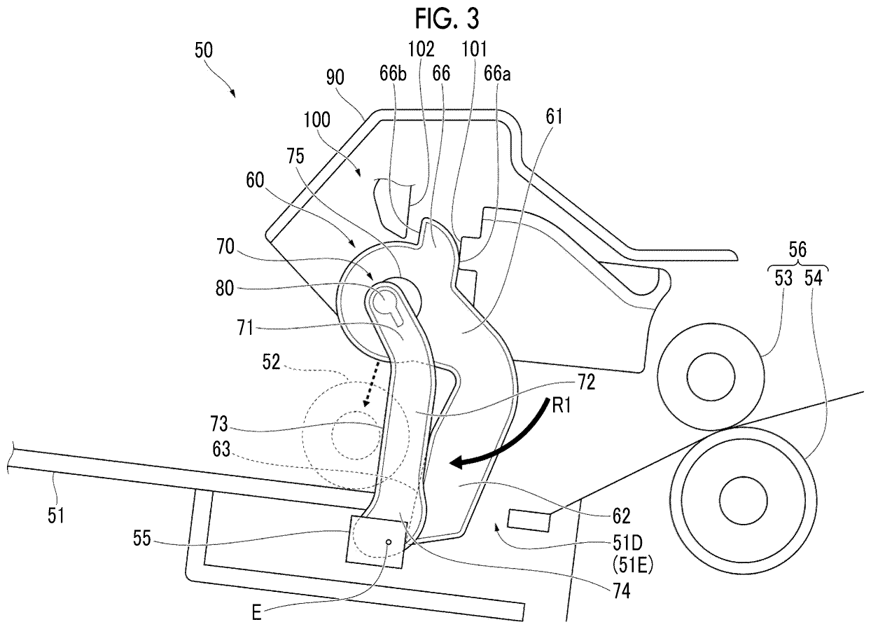

Next, the manual feed device 50 in the present exemplary embodiment will be described with reference to FIGS. 2 and 3.

FIG. 2 is a perspective view showing the manual feed device 50 as seen in a direction along an arrow II of FIG. 1. FIG. 3 is a view showing the manual feed device 50 as seen from a front side of the paper surface of FIG. 1. FIGS. 2 and 3 show a state where no paper sheet is supplied to the manual feed device 50. In a case where the manual feed device 50 is an independent transaction target, such as a replacement component or a separately attached component, the manual feed device 50 is an example of a paper feeding device.

As shown in FIG. 2, the manual feed device 50 is provided with a tray 51 serving as a transportation path along which a paper sheet or a bundle of paper sheets is transported. In addition, the manual feed device 50 includes a feeding roll 52 that feeds, to the downstream side, a paper sheet supplied to the tray 51. The feeding roll 52 is an example of a transportation member. In addition, the manual feed device 50 includes a separation unit 56 that separates paper sheets fed by the feeding roll 52 in an one-by-one manner and that feeds the paper sheets to the downstream side (refer to FIG. 3). The separation unit 56 is composed of a feed roll 53 that is disposed to be rotatable and a retard roll 54 of which rotation is limited. In addition, the manual feed device 50 includes a cover member 90 that covers an upper side of the feeding roll 52 and the like.

In addition, the manual feed device 50 includes a regulation member 60 that is provided on the tray 51 serving as a paper sheet transportation path and that regulates the position (hereinafter, may be referred to as a “transportation start position”) of a leading end of a paper sheet in a transportation direction. In addition, the manual feed device 50 includes a stopping mechanism 100 that limits movement of the regulation member 60 to a certain range. In addition, the manual feed device 50 includes a detection member 70 used to detect the presence or absence of a paper sheet.

In addition, the manual feed device 50 includes a detection sensor 55 that detects the presence or absence of a paper sheet based on the position or movement of the detection member 70. The detection sensor 55 in the present exemplary embodiment is composed of, for example, a noncontact sensor such as an optical sensor. Examples of the optical sensor include a light-blocking type sensor and a transmission type sensor. In the present exemplary embodiment, for example, the presence or absence of a paper sheet is detected by using, as the detection sensor 55, a light-blocking type sensor including a light emitting unit E and a light receiving unit. Note that the detection sensor 55 is not limited thereto as long as the position of the detection member 70 can be detected.

Note that the separation unit 56 may be configured to be provided on the housing 1A side of the image forming apparatus 1.

A paper sheet is placed on the tray 51, the tray 51 has a function as the transportation path for transportation of paper sheets, and the tray 51 is formed in a plate-like shape. The tray 51 includes a supporting surface (hereinafter, will be referred to as a “paper supporting surface 51C”) that supports a paper sheet from below. A first through-hole 51D and a second through-hole 51E, through which an upper side and a lower side communicate with each other with the tray 51 interposed therebetween, are formed in the paper supporting surface 51C of the tray 51.

The manual feed device 50 in the present exemplary embodiment is provided with a rotation shaft 75 that extends in a direction orthogonal to the paper sheet transportation direction to be parallel with the paper supporting surface 51C of the tray 51 and that serves as a first rod-shaped member. The rotation shaft 75 is installed to be movable up and down with respect to the paper supporting surface 51C of the tray 51. In addition, the rotation shaft 75 is a rotation shaft of the feeding roll 52 and supports the regulation member 60.

The rotation shaft 75 moves up and down to position the feeding roll 52 upward at the time of a standby period before transportation of a paper sheet and to position the feeding roll 52 downward at the time of the transportation of the paper sheet. As shown in FIG. 3, the feeding roll 52 moves downward as the rotation shaft 75 moves in a downward direction at the time of transportation of a paper sheet so that the feeding roll 52 moves to a position at which the feeding roll 52 comes into contact with a bundle of paper sheets.

The regulation member 60 includes a supporting portion 61, an arm 62 extending from the supporting portion 61, and an abutting surface 63 that functions as an abutting portion that a paper sheet abuts. In the present exemplary embodiment, the regulation member 60 is provided above the first through-hole 51D formed in the tray 51 and the arm 62 of the regulation member 60 is formed to protrude downward beyond the first through-hole 51D with the tray 51 interposed therebetween.

The supporting portion 61 supports the regulation member 60 such that the regulation member 60 is rotatable with respect to the rotation shaft 75. Accordingly, the supporting portion 61 swings around the rotation shaft 75. A projection portion 66 is formed on the supporting portion 61. The projection portion 66 is used to limit movement of the regulation member 60 swinging around the rotation shaft 75 to the certain range. More specifically, movement of the regulation member 60 between a state where a paper sheet is not placed on the tray 51 and a state where a paper sheet is placed on the tray 51 and the paper sheet abuts the regulation member 60 up to the transportation start position is defined.

The arm 62 prompts the regulation member 60 to swing, the regulation member 60 moving due to the weight of the regulation member 60. The abutting surface 63 is formed on the arm 62, and the shape of the arm 62 has a role of determining an abutting position of a paper sheet. In the present exemplary embodiment, the arm 62 is formed to extend in an L-shape from the supporting portion 61, and the abutting surface 63 is formed on an inner side of the L-shape. Since the abutting surface 63 is formed in such a manner, the abutting surface 63 can have, for example, a shape that extends in, for example, a direction approximately orthogonal to the paper supporting surface 51C and that is preferable for transportation of a paper sheet in a case where a leading end of a paper sheet abuts the abutting surface 63.

In addition, the abutting surface 63 has a certain thickness with respect to a width direction of a paper sheet, which is a direction orthogonal to the paper sheet transportation direction. Accordingly, a paper sheet abutting the abutting surface 63 is received by a surface and the paper sheet stably abuts the abutting surface 63. In addition, the abutting surface 63 is formed to have a certain height with respect to the paper supporting surface 51C. Accordingly, an abutting position of a bundle of paper sheets of which the number does not exceed a predetermined number is determined. That is, even in a case where a plurality of paper sheets are supplied to the tray 51, an uppermost paper sheet and a lowermost paper sheet are supported with respect to the abutting surface 63 at the substantially same angles and the degree to which the paper sheets are positionally offset from each other in a case where the paper sheets are set may be reduced.

As described above, the regulation member 60 is formed in a predetermined shape and has a certain weight for realization of a stable paper sheet abutting function.

In the manual feed device 50 of the present exemplary embodiment, the stopping mechanism 100 that limits movement of the swinging regulation member 60 to the certain range is formed including a position where the supporting portion 61 at an upper portion of the regulation member 60 is formed. The stopping mechanism 100 includes the projection portion 66 formed at the supporting portion 61 and includes a first abutting wall 101 and a second abutting wall 102 that come into contact with the projection portion 66. At the time of transportation of a paper sheet, the second abutting wall 102 withdraws to a position where movement of the regulation member 60 is not hindered.

The projection portion 66 includes a first surface 66a that comes into contact with the first abutting wall 101 and a second surface 66b that comes into contact with the second abutting wall 102. With the first surface 66a of the projection portion 66 coming into contact with the first abutting wall 101, the position of the regulation member 60 before the setting of a paper sheet is determined. In addition, with the second surface 66b of the projection portion 66 coming into contact with the second abutting wall 102, the position of the regulation member 60 after the setting of a paper sheet is determined.

Furthermore, as shown in FIG. 2, the manual feed device 50 in the present exemplary embodiment is provided with a shaft member 80 that extends in a direction orthogonal to the paper sheet transportation direction to be parallel with the paper supporting surface 51C of the tray 51 and that serves as a second rod-shaped member. The shaft member 80 supports the detection member 70 above the second through-hole 51E formed in the tray 51.

As shown in FIG. 3, the detection member 70 includes a supporting portion 71 and an arm 72 extending from the supporting portion 71. In addition, the detection member 70 includes an abutting surface 73 that a paper sheet abuts and a detection region 74 that is a region detected by the detection sensor 55.

The supporting portion 71 of the detection member 70 supports the detection member 70 such that the detection member 70 is rotatable with respect to the shaft member 80. Accordingly, the supporting portion 71 swings around the shaft member 80. In a case where a paper sheet is not set, the detection member 70 is stopped due to the weight of the detection member 70 at a position where the detection member 70 is stabilized.

The arm 72 of the detection member 70 prompts the detection member 70 to swing, the detection member 70 moving due to the weight of the detection member 70. The abutting surface 73 of the detection member 70 is formed on the arm 72, and a leading end of a paper sheet abuts the abutting surface 73.

The detection region 74 is a target region to be detected by the detection sensor 55, and is provided below the arm 72 in the present exemplary embodiment. In the case of the detection member 70 in the present exemplary embodiment, the abutting surface 73 is formed above the second through-hole 51E formed in the tray 51 and the detection region 74 is formed below the second through-hole 51E. In other words, the abutting surface 73 of the detection member 70 is formed on the transportation path and the detection region 74 is formed on a side opposite to the abutting surface 73 with the tray 51 interposed therebetween.

In addition, in the present exemplary embodiment, the detection member 70 is disposed such that the detection region 74 blocks light emitted from the light emitting unit E of the detection sensor 55 at a position where the detection member 70 is positioned due to the weight of the detection member 70.

The detection sensor 55 in the present exemplary embodiment is disposed at a position where the detection sensor 55 does not hinder transportation of a paper sheet. More specifically, the detection sensor 55 is provided below the tray 51 that functions as a paper sheet transportation path. In addition, the detection sensor 55 in the present exemplary embodiment is disposed upstream of the regulation member 60 in the paper sheet transportation direction.

### Movement of Regulation Member and Detection Member

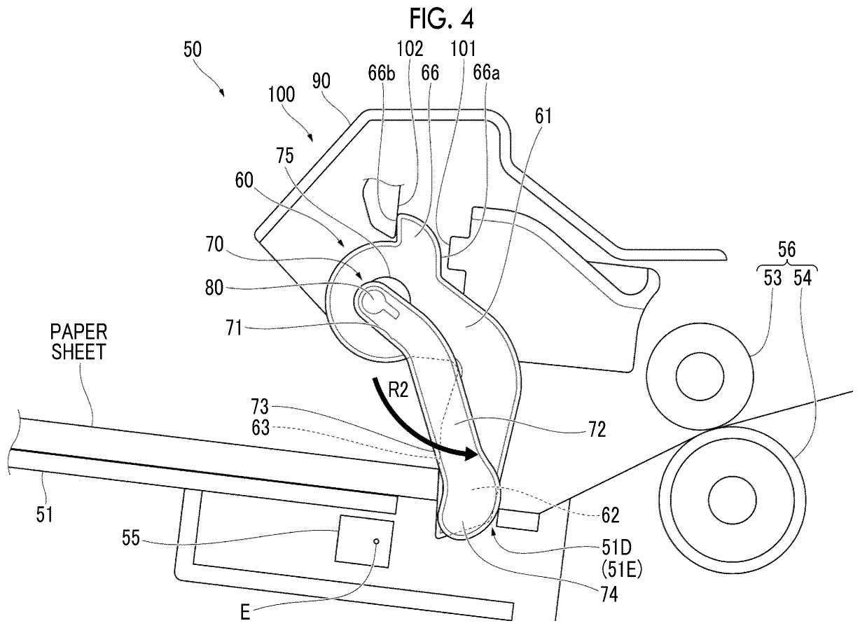

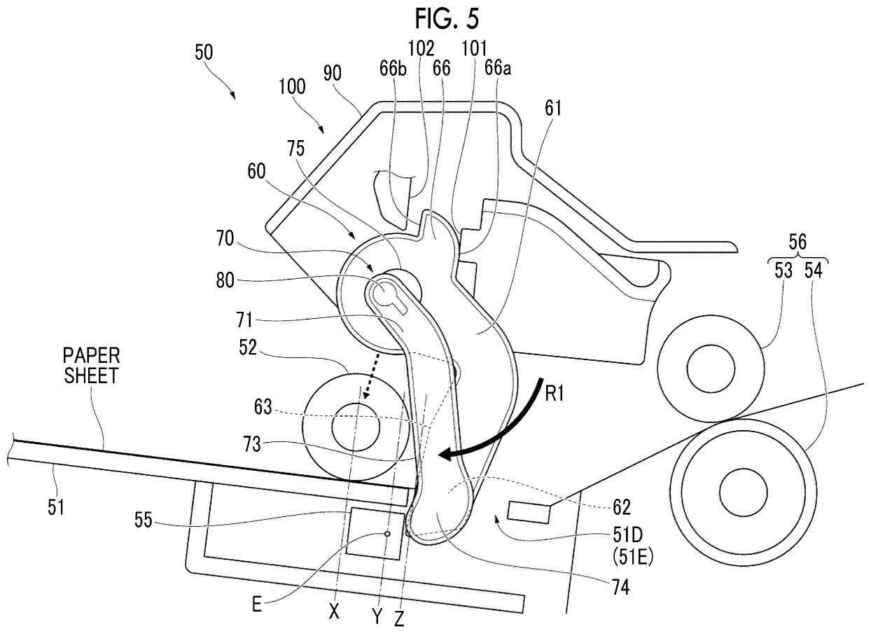

FIG. 4 is an explanatory view for description of the manual feed device 50 in a state where a paper sheet has been supplied to the tray 51. FIG. 5 is an explanatory view for description of the manual feed device 50 in a state where a paper sheet supplied to the tray 51 has been pushed back.

Movement of the regulation member 60 and the detection member 70 will be described with reference to FIGS. 3 to 5.

As shown in FIG. 3, in a state before paper setup where there is no paper sheet supplied to the tray 51, the regulation member 60 moves in a direction along a clockwise direction R1 shown in FIG. 3 due to the weight of the regulation member 60 after a previous paper sheet is transported and stands by at a position shown in FIG. 3. In this case, the first surface 66a of the projection portion 66 of the regulation member 60 is in contact with the first abutting wall 101. Accordingly, a position where the regulation member 60 is stopped due to the weight of the regulation member 60 is determined. In addition, in this case, the abutting surface 63 of the regulation member 60 is at a position before paper setup at which a user can set a paper sheet.

In addition, in a state before paper setup where there is no paper sheet supplied to the tray 51, the detection member 70 moves in the direction along the clockwise direction R1 shown in FIG. 3 due to the weight of the detection member 70 after a previous paper sheet is transported and is at a position shown in FIG. 3.

As shown in FIG. 4, in a case where a paper sheet is supplied to the tray 51, the regulation member 60 in a state as shown in FIG. 3 moves in a direction along a counterclockwise direction R2 since the abutting surface 63 is pressed due to insertion of the paper sheet. In this case, in a case where the size of the paper sheet is not small, a case where the number of paper sheets is large, or a case where the paper sheet is firm, the regulation member 60 does not push back the paper sheet and movement of the regulation member 60 is stopped since the second surface 66b of the projection portion 66 comes into contact with the second abutting wall 102. Accordingly, the abutting surface 63 of the regulation member 60 is set at the transportation start position of the paper sheet.

In addition, in a case where a paper sheet is supplied to the tray 51, the detection member 70 in a state as shown in FIG. 3 moves in a direction along the counterclockwise direction R2 since the abutting surface 73 is pressed due to insertion of the paper sheet. Then, the detection member 70 stops movement together with the regulation member 60 at a position where the regulation member 60 stops movement in the paper sheet transportation direction.

In this case, light emitted from the light emitting unit E is not blocked by the detection region 74 since the detection member 70 has moved to the downstream side in the paper sheet transportation direction. In a case where the light emitted from the light emitting unit E is not blocked by the detection region 74, the detection sensor 55 detects that a paper sheet is present.

Here, for example, a case where a paper sheet set in the tray 51 is small and light, a case where the number of paper sheets is small, a case where a paper sheet is soft and flexible, and the like will be considered.

In such a case, a leading end of the paper sheet may be pushed back due to the weight of the regulation member 60 or the detection member 70 even though the paper sheet is set in the tray 51. More specifically, for example, in a case where the number of paper sheets on the tray 51 is small or the like as shown in FIG. 5, a force that is caused by the weight of the regulation member 60 or the detection member 70 and that pushes the paper sheets back to the upstream side may be dominant. In this case, the regulation member 60 and the detection member 70 move in a direction along the clockwise direction R1 so that the paper sheets set in the tray 51 are pushed back to the upstream side in the paper sheet transportation direction.

Particularly, the paper sheets set in the tray 51 are pushed back to the upstream side by the regulation member 60 having a certain weight.

Here, the detection sensor 55 in the present exemplary embodiment is disposed upstream of the regulation member 60 in the paper sheet transportation direction. More specifically, the detection sensor 55 is disposed upstream of a swinging range of the regulation member 60, that is, a region where the regulation member 60 moves in the paper sheet transportation direction. Therefore, in the present exemplary embodiment, in a case where the regulation member 60 moves to a position where the regulation member 60 is stopped due to the weight of the regulation member 60, the detection member 70 moves together with the movement of the regulation member 60 but stays at a position shown in FIG. 5 without returning to a position shown in FIG. 3. At the position shown in FIG. 5, light emitted from the light emitting unit E is not blocked by the detection region 74 of the detection member 70. Accordingly, the detection sensor 55 detects that a paper sheet is present even in a case where a paper sheet is pushed back by the regulation member 60.

In the present exemplary embodiment, the detection sensor 55 detects the presence of a paper sheet at a position upstream of the regulation member 60 in the paper sheet transportation direction with respect to the regulation member 60 that is stopped at the transportation start position of a paper sheet with a leading end of the paper sheet abutting the abutting surface 63 of the regulation member 60. Meanwhile, the detection sensor 55 detects the presence of a paper sheet at the position upstream of the regulation member 60 in the paper sheet transportation direction with respect to the regulation member 60 moving to the upstream side in the paper sheet transportation direction due to the weight of the regulation member 60 as well. That is, in the present exemplary embodiment, even in a case where a paper sheet is returned to the upstream side in the paper sheet transportation direction by the regulation member 60, the presence or absence of the paper sheet is detected at a position to which the paper sheet is returned.

Next, the position of the feeding roll 52 at the time of transportation of a paper sheet will be described with reference to FIG. 5.

In a case where an instruction to transport paper sheets supplied to the tray 51 is issued, the rotation shaft 75 moves downward. In a case where the rotation shaft 75 moves downward, the feeding roll 52 provided to be coaxial with the rotation shaft 75 moves downward and comes into contact with the paper sheets supplied to the tray 51.

Then, the feeding roll 52 is rotationally driven and thus the paper sheets are transported. In this case, the regulation member 60 is allowed to rotate in the counterclockwise direction, the paper sheets move while pressing the abutting surface 63 of the regulation member 60, and the paper sheets move to the separation unit 56. Thereafter, the paper sheets separated in an one-by-one manner by the separation unit 56 are moved to a downstream side in a paper sheet transportation path.

In the manual feed device 50 of the present exemplary embodiment, a position X where the feeding roll 52 and a paper sheet come into contact with each other, a position Y where the detection sensor 55 detects a paper sheet, and a position Z where the regulation member 60 is stopped due to the weight of the regulation member 60 are provided in this order from the upstream side in the paper sheet transportation direction.

That is, the position X where the feeding roll 52 in the present exemplary embodiment and a paper sheet come into contact with each other is positioned upstream of the position Z in the paper sheet transportation direction, the position Z being a position where the regulation member 60 is stopped due to the weight of the regulation member 60. In addition, the position X where the feeding roll 52 in the present exemplary embodiment and a paper sheet come into contact with each other is positioned upstream of the position Y in the paper sheet transportation direction, the position Y being a position where the detection sensor 55 detects a paper sheet.

Therefore, the manual feed device 50 in the present exemplary embodiment is a mechanism in which a paper sheet pushed back can be detected and transported to a downstream side by the feeding roll 52 even in a case where the paper sheet is pushed back by the regulation member 60.

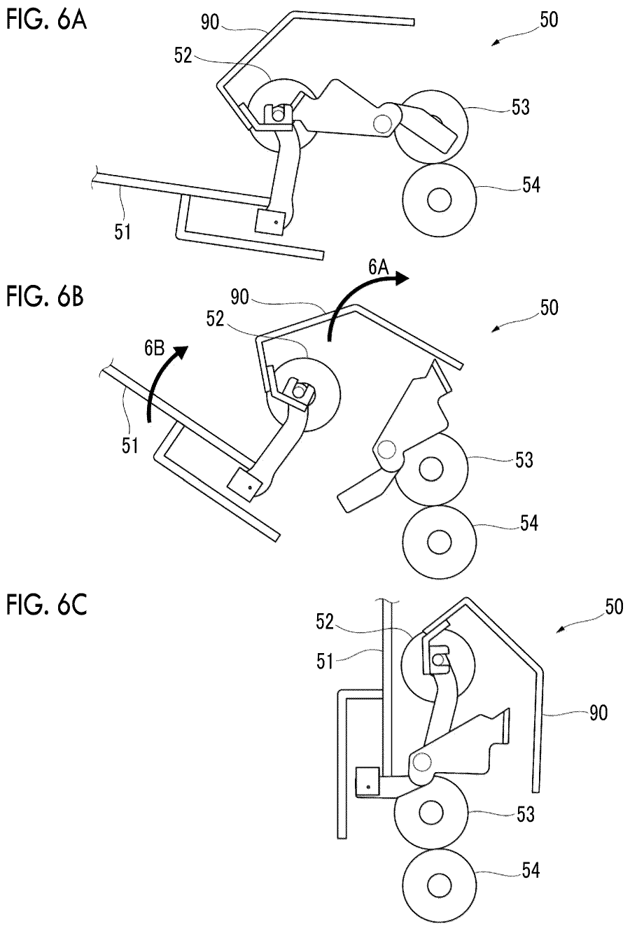

FIGS. 6A to 6C are explanatory views for description of a positional relationship between the opening and closing of the tray 51 of the manual feed device 50 and the feeding roll 52, where FIG. 6A is a view showing a state where the tray 51 is open, FIG. 6B is a view showing a process in which the tray 51 is closed, and FIG. 6C is a view showing a state where the tray 51 is closed.

The manual feed device 50 in the present exemplary embodiment is stored in the image forming apparatus 1 by being rotated to be opened and closed with respect to the housing 1A.

More specifically, in a case where an operation of closing the tray 51 is performed in a state where the manual feed device 50 is open as shown in FIG. 6A, each of the cover member 90 and the tray 51 is rotated to be opened and closed in directions along clockwise directions 6A and 6B shown in FIG. 6B. Then, in a case where the operation of closing the manual feed device 50 is completed, as shown in FIG. 6C, each of the cover member 90 and the tray 51 is stored to be orthogonal to a horizontal direction of the housing 1A. In this case, the feeding roll 52 below the cover member 90 is also moved together with the cover member 90 in the direction along the clockwise direction 6A while moving along an arc and is stored in the housing 1A. In the present exemplary embodiment, since the manual feed device 50 can be rotated to be opened and closed with respect to the housing 1A, it is possible to reduce the machine width of the image forming apparatus 1 and to dispose the feeding roll 52 at a position farther from the housing 1A in an open state.

The feeding roll 52 in the open state as shown in FIG. 6A is positioned to considerably protrude from the housing 1A side of the image forming apparatus 1 in comparison with the position of the feeding roll 52 in a closed state as shown in FIG. 6C. Accordingly, a positional relationship of the manual feed device 50 shown in FIG. 3 is realized, and a paper sheet pushed back by the regulation member 60 can be transported.

Although the exemplary embodiment of the present invention has been described above, the technical scope of the exemplary embodiment of the present invention is not limited to the above exemplary embodiment. The exemplary embodiment of the present invention is not limited to a manual feed device and can be applied to, for example, an auto document feeder (ADF) that automatically feeds, to an image reading unit, paper sheets supplied thereto in an one-by-one manner. In addition, various modifications and alternative configurations are involved in the present invention without departing from the technical scope of the present invention.

### SUPPLEMENTARY NOTE

(((1)))

A paper feeding device comprising:
a regulation member that includes an abutting portion abutting a leading end of a supplied paper sheet to regulate a transportation start position of the paper sheet and of which the abutting portion moves in a transportation direction of the paper sheet; and
a detection unit that detects presence or absence of the paper sheet at a position to which the paper sheet is returned in a case where the paper sheet is returned by the regulation member.
(((2)))

The paper feeding device according to (((1))),
wherein the detection unit detects the presence or absence of the paper sheet at a position upstream of the regulation member in the transportation direction with respect to the regulation member that is stopped at the transportation start position of the paper sheet with the leading end of the paper sheet abutting the abutting portion.
(((3)))

The paper feeding device according to (((1))) or (((2))),
wherein the regulation member is provided to be rotatable around a rotation shaft extending in a width direction of the paper sheet, the width direction being a direction intersecting the transportation direction, and
the detection unit detects the presence or absence of the paper sheet at a position upstream of the regulation member in the transportation direction with respect to the regulation member of which the abutting portion moves to an upstream side in the transportation direction due to a weight of the regulation member.
(((4)))

The paper feeding device according to any one of (((1))) to (((3))),
wherein, in the transportation direction, a region where the detection unit detects the paper sheet is provided upstream of a region where the abutting portion moves in the transportation direction.
(((5)))

The paper feeding device according to any one of (((1))) to (((4))), further comprising:
a transportation member that transports the supplied paper sheet to a downstream side in the transportation direction,
wherein the transportation member is provided upstream of a region where the paper sheet is detected, in the transportation direction.
(((6)))

An image forming apparatus comprising:
the paper feeding device according to any one of (((1))) to (((5))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper feeding device comprising:
a regulation member that includes an abutting portion abutting a leading end of a supplied paper sheet to regulate a transportation start position of the paper sheet and of which the abutting portion moves in a transportation direction of the paper sheet; and
a detection unit that detects presence or absence of the paper sheet at a position to which the paper sheet is returned in a case where the paper sheet is returned by the regulation member.

2. The paper feeding device according to claim 1,
wherein the detection unit detects the presence or absence of the paper sheet at a position upstream of the regulation member in the transportation direction with respect to the regulation member that is stopped at the transportation start position of the paper sheet with the leading end of the paper sheet abutting the abutting portion.

3. The paper feeding device according to claim 2,
wherein the regulation member is provided to be rotatable around a rotation shaft extending in a width direction of the paper sheet, the width direction being a direction intersecting the transportation direction, and
the detection unit detects the presence or absence of the paper sheet at a position upstream of the regulation member in the transportation direction with respect to the regulation member of which the abutting portion moves to an upstream side in the transportation direction due to a weight of the regulation member.

4. The paper feeding device according to claim 1,
wherein, in the transportation direction, a region where the detection unit detects the paper sheet is provided upstream of a region where the abutting portion moves in the transportation direction.

5. The paper feeding device according to claim 4, further comprising:
a transportation member that transports the supplied paper sheet to a downstream side in the transportation direction,
wherein the transportation member is provided upstream of a region where the paper sheet is detected, in the transportation direction.

6. An image forming apparatus comprising:
the paper feeding device according to claim 1.

7. An image forming apparatus comprising:
the paper feeding device according to claim 2.

8. An image forming apparatus comprising:
the paper feeding device according to claim 3.

9. An image forming apparatus comprising:
the paper feeding device according to claim 4.

10. An image forming apparatus comprising:
the paper feeding device according to claim 5.
